(19) United States
(12) Patent Application Publication
(10) Pub. No.: US 2026/0011310 A1
(43) Pub. Date: Jan. 8, 2026

(54) DISPLAY PANEL AND DISPLAY APPARATUS

(71) Applicant: Wuhan Tianma Microelectronics Co., Ltd., Wuhan (CN)

(72) Inventor: Ying ZHENG, Wuhan (CN)

(21) Appl. No.: 19/325,484

(22) Filed: Sep. 10, 2025

(30) Foreign Application Priority Data
May 14, 2025 (CN) 202510624822.5

(51) Int. Cl. G09G 3/3233

(52) U.S. Cl. CPC G09G 3/3233; G09G 2300/0842; G09G 2300/0861; G09G 2310/08; G09G 2320/0233

(57) ABSTRACT

Provided are a display panel and a display apparatus. The display panel includes a plurality of pixel circuits and a plurality of light-emitting devices, wherein the pixel circuits are electrically connected to the light-emitting devices, each pixel circuit includes a driving transistor and a data writing transistor, the driving transistor is configured to generate a driving current, and the data writing transistor is electrically connected to a first electrode of the driving transistor; an operation of the pixel circuit includes a data writing stage and a bias stage; and the display panel further includes a writing frame, and in the writing frame: the data writing transistor is turned on in the data writing stage to write a data voltage to the driving transistor; and the data writing transistor is turned on in the bias stage to write a first bias voltage to the first electrode of the driving transistor.

### CROSS-REFERENCE TO RELATED APPLICATION

The present application claims priority to Chinese Patent Application No. 202510624822.5, filed on May 14, 2025, the content of which is incorporated herein by reference in its entirety.

### TECHNICAL FIELD

The present application relates to the field of display technologies, and in particular, to a display panel and a display apparatus.

### BACKGROUND

Organic light-emitting diode (OLED) is a device that uses a multi-layer organic thin film structure to generate electroluminescence. Compared with a liquid crystal display screen, an OLED display screen is thinner and lighter, with higher brightness, lower power consumption, faster response, higher definition, better flexibility, and higher luminous efficiency, which can meet consumers' new demands for display technologies. A pixel circuit is arranged in the OLED display screen to drive an OLED light-emitting device, and as the usage time increases, the internal characteristics of a driving transistor in the pixel circuit will change slowly, causing a threshold voltage of the driving transistor to drift, thereby affecting display uniformity.

### SUMMARY

Embodiments of the present application provide a display panel and a display apparatus to solve the problem that the threshold voltage drifting of the driving transistor affects display uniformity.

In a first aspect, an embodiment of the present application provides a display panel, including a plurality of pixel circuits and a plurality of light-emitting devices, where the pixel circuits are electrically connected to the light-emitting devices, each pixel circuit includes a driving transistor and a data writing transistor, the driving transistor is configured to generate a driving current, and the data writing transistor is electrically connected to a first electrode of the driving transistor;

where an operation of the pixel circuit includes a data writing stage and a bias stage; and

where the display panel further includes a writing frame, and in the writing frame:

the data writing transistor is turned on in the data writing stage to write a data voltage to the driving transistor; and

the data writing transistor is turned on in the bias stage to write a first bias voltage to the first electrode of the driving transistor.

In a second aspect, the present application provides a display apparatus including the display panel according to any of the embodiments of the present application.

The display panel and the display apparatus according to the embodiments of the present application have the following beneficial effects: the operation of the pixel circuit in the writing frame includes the data writing stage and the bias stage, the data writing transistor is turned on once in the data writing stage to write the data voltage to the driving transistor, and the data writing transistor is turned on once in the bias stage to write the first bias voltage to the first electrode of the driving transistor. The data writing transistor is used to write the first bias voltage in the writing frame to adjust a bias state of the driving transistor, which can improve the display unevenness caused by the threshold shift due to the driving transistor operating in a forward bias state for a long time, and the data writing transistor is reused, which can reduce the space occupied by the pixel circuit and meet the wiring requirements of high PPI.

### BRIEF DESCRIPTION OF DRAWINGS

To more clearly illustrate the technical solutions in the embodiments of the present application or in the prior art, a brief introduction to the accompanying drawings required to be used in the description of the embodiments or the prior art will be given below. Apparently, the accompanying drawings in the following description are some embodiments of the present application, and for those of skill in the art, other accompanying drawings can also be obtained based on these drawings without creative efforts.

FIG. 1 is a schematic diagram of a pixel circuit according to an embodiment of the present application;

FIG. 2 is an operation timing diagram of a pixel circuit according to an embodiment of the present application;

FIG. 3 is a schematic diagram of a display panel according to an embodiment of the present application;

FIG. 4 is another timing diagram according to an embodiment of the present application;

FIG. 5 is a schematic diagram of another display panel according to an embodiment of the present application;

FIG. 6 is a timing diagram of another pixel circuit according to an embodiment of the present application;

FIG. 7 is a schematic diagram of another pixel circuit according to an embodiment of the present application;

FIG. 8 is a timing diagram of another pixel circuit according to an embodiment of the present application;

FIG. 9 is a schematic diagram of another pixel circuit according to an embodiment of the present application;

FIG. 10 is a schematic diagram of another pixel circuit according to an embodiment of the present application;

FIG. 11 is an operation timing diagram of another pixel circuit according to an embodiment of the present application; and

FIG. 12 is a schematic diagram of a display apparatus according to an embodiment of the present application.

### DESCRIPTION OF EMBODIMENTS

To make the objectives, technical solutions, and advantages of the embodiments of the present application clearer, the technical solutions in the embodiments of the present application will be clearly and completely described below in conjunction with the accompanying drawings in the embodiments of the present application. Apparently, the described embodiments are a part of the embodiments of the present application, rather than all the embodiments. Based on the embodiments of the present application, all other embodiments obtained by those of ordinary skill in the art without creative efforts shall fall within the protection scope of the present application.

The terms used in the embodiments of the present application are merely for the purpose of describing specific embodiments and are not intended to limit the present application. The singular forms of “a/an”, “said” and “the” used in the embodiments of the present application and the appended claims are also intended to include the plural forms, unless the context clearly indicates otherwise.

Embodiments of the present application provide a display panel and a display apparatus, in which a data writing transistor is used to write a bias voltage to a first electrode of a driving transistor in a writing frame of the display panel to adjust a bias state of the driving transistor, which can improve the display unevenness caused by the threshold shift due to the driving transistor operates in a forward bias state for a long time. Moreover, the data writing transistor is used to provide the bias voltage in the writing frame, and thus the data writing transistor is reused, which can reduce the space occupied by the pixel circuit and meet the wiring requirements of high PPI (Pixels Per Inch). The above is the main technical concept of embodiments of the present application, and the present application is illustrated with specific examples in the following specific embodiments.

An embodiment of the present application provides a display panel including a plurality of pixel circuits and a plurality of light-emitting devices. The light-emitting device may be, for example, an OLED light-emitting device, and the pixel circuit is electrically connected to the light-emitting device and configured to drive the light-emitting device to emit light.

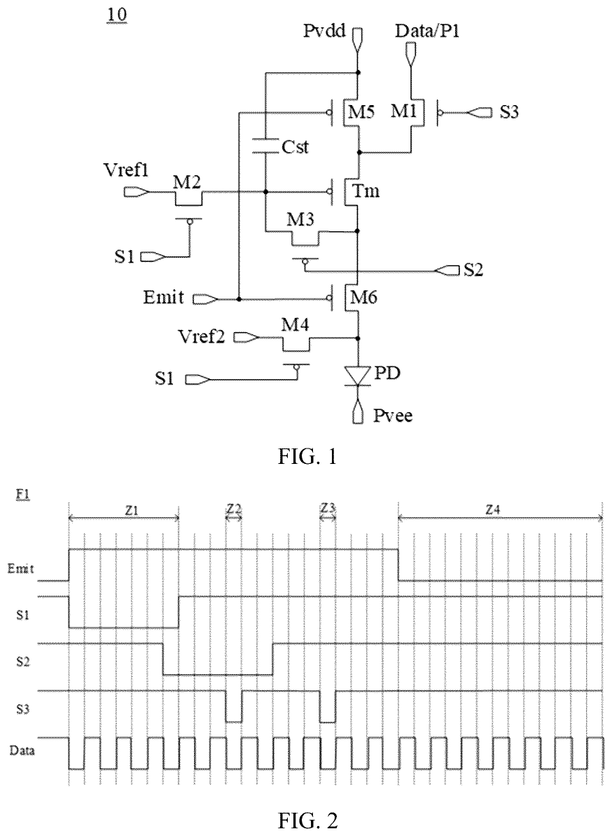

FIG. 1 is a schematic diagram of a pixel circuit according to an embodiment of the present application, and FIG. 2 is an operation timing diagram of the pixel circuit according to an embodiment of the present application.

As shown in FIG. 1, the pixel circuit 10 includes a driving transistor Tm, a data writing transistor M1, a gate reset transistor M2, a threshold compensation transistor M3, an electrode reset transistor M4, a first light-emitting control transistor M5, a second light-emitting control transistor M6, and a storage capacitor Cst. The driving transistor Tm is connected in series between the first light-emitting control transistor M5 and the second light-emitting control transistor M6, the first light-emitting control transistor M5 is connected to a first power supply end Pvdd, the second light-emitting control transistor M6 is connected to a first electrode of a light-emitting device PD, and a second electrode of the light-emitting device PD is connected to a second power supply end Pvee. A control terminal of the gate reset transistor M2 and a control terminal of the electrode reset transistor M4 receive a scanning signal S1, a control terminal of the threshold compensation transistor M3 receives a scanning signal S2, a control terminal of the data writing transistor M1 receives a scanning signal S3, and control terminals of the first light-emitting control transistor M5 and the second light-emitting control transistor M6 receive a light-emitting control signal Emit. The driving transistor Tm is configured to generate a driving current, and the data writing transistor M1 is electrically connected to a first electrode of the driving transistor Tm.

An operation of the pixel circuit 10 includes a data writing stage and a bias stage, and a process of the operation of the pixel circuit 10 is understood in conjunction with FIG. 2. FIG. 1 schematically shown with each transistor being a p-type transistor, and the timing diagram in FIG. 2 schematically shows that a low level signal controls the p-type transistor to be turned on.

As shown in FIG. 2, the display panel includes a writing frame F1, and the operation of the pixel circuit in the writing frame F1 includes a reset stage Z1, a data writing stage Z2, a bias stage Z3 and a light-emitting stage Z4; FIG. 2 schematically shows that a data line provides a data voltage Data with voltage jump, and in fact, a voltage value of the data voltage Data is related to the gray level displayed by the light-emitting device PD connected to the data line, and the data voltage Data in FIG. 2 is only schematically represented. It can be understood that a plurality of scan lines are arranged in the display panel, and the scan lines each are connected to a plurality of pixel circuits 10 in one pixel circuit row. The plurality of scan lines sequentially provide scanning signals from top to bottom to realize row-by-row driving of the plurality of pixel circuit rows to complete one frame. In the embodiment of the present application, the writing frame F1 is one frame of the display panel. In the writing frame F1:

The gate reset transistor M2 is turned on in the reset stage Z1 to reset a gate of the driving transistor Tm, and at the same time, the electrode reset transistor M4 is turned on in the reset stage Z1 to reset the first electrode of the light-emitting device PD. Specifically, in the reset stage Z1, the scanning signal S1 provides a low-level effective level to control the gate reset transistor M2 and the electrode reset transistor M4 to be turned on respectively.

The data writing transistor M1 is turned on in the data writing stage Z2 to write the data voltage Data to the driving transistor Tm; and the threshold compensation transistor M3 is turned on in the data writing stage Z2 to write the data voltage Data to the gate of the driving transistor Tm and compensate a threshold voltage of the driving transistor Tm. In the data writing stage Z2, the scanning signal S2 provides an effective level to control the threshold compensation transistor M3 to be turned on, and the scanning signal S3 provides an effective level to control the data writing transistor M1 to be turned on. In an overlapping period between the low level of the scanning signal S2 and the low level of the scanning signal S3, the data voltage Data is written to the gate of the driving transistor Tm to compensate the threshold voltage of the driving transistor Tm.

The data writing transistor M1 is turned on in the bias stage Z3 to write a first bias voltage P1 to the first electrode of the driving transistor Tm. Specifically, in the bias stage Z3, the scanning signal S3 provides an effective level to control the data writing transistor M1 to be turned on, and a bias state of the driving transistor Tm is adjusted by using the first bias voltage P1.

The first light-emitting control transistor M5 and the second light-emitting control transistor M6 are turned on in the light-emitting stage Z4, the driving transistor Tm generates the driving current and provides the driving current to the first electrode of the light-emitting device PD, and the light-emitting device PD emits light under control of voltages of the first electrode and the second electrode thereof. Specifically, in the light-emitting stage Z4, the light-emitting control signal Emit provides an effective level to control the first light-emitting control transistor M5 and the second light-emitting control transistor M6 to be turned on.

In the display panel provided by the embodiment of the present application, the operation of the pixel circuit 10 in the writing frame F1 includes the data writing stage Z2 and the bias stage Z3. The data writing transistor M1 is turned on once in the data writing stage Z2 to write the data voltage Data to the driving transistor Tm, and the data writing transistor M1 is turned on once in the bias stage Z3 to write the first bias voltage P1 to the first electrode of the driving transistor Tm. In the writing frame F1, using the data writing transistor M1 to write the first bias voltage P1 to adjust the bias state of the driving transistor Tm can improve the display unevenness caused by the threshold shift due to the driving transistor Tm operating in a forward bias state for a long time, and the reuse of the data writing transistor M1 can reduce the space occupied by the pixel circuit 10, which can meet the wiring requirements of high PPI.

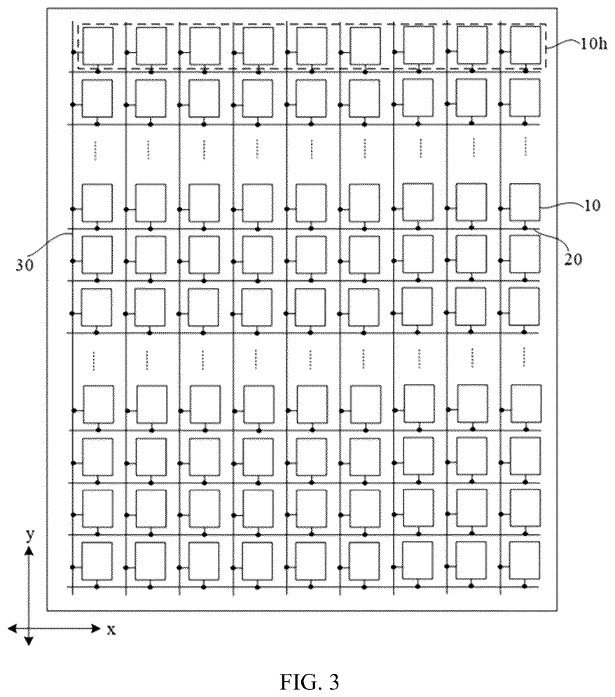

In some implementations, FIG. 3 is a schematic diagram of a display panel according to an embodiment of the present application. As shown in FIG. 3, a plurality of pixel circuits 10 are arranged in a pixel circuit row 10h in a first direction x, and a plurality of pixel circuit rows 10h are arranged in a second direction y, the second direction y intersecting with the first direction x. The display panel includes scan lines 20 extending along the first direction x and data lines 30 extending along the second direction y. The pixel circuits 10 in FIG. 3 are shown for simplified illustration only, and the structures of the pixel circuits 10 can refer to the schematic diagram of FIG. 1. The scan lines 20 each are electrically connected to the plurality of pixel circuits 10 in one pixel circuit row 10h, for example, the scan lines 20 each are electrically connected to the gate reset transistors M2 in the plurality of pixel circuits 10 arranged in the first direction x. The data lines 30 each are electrically connected to the data writing transistors M1 in the plurality of pixel circuits 10 arranged in the second direction y.

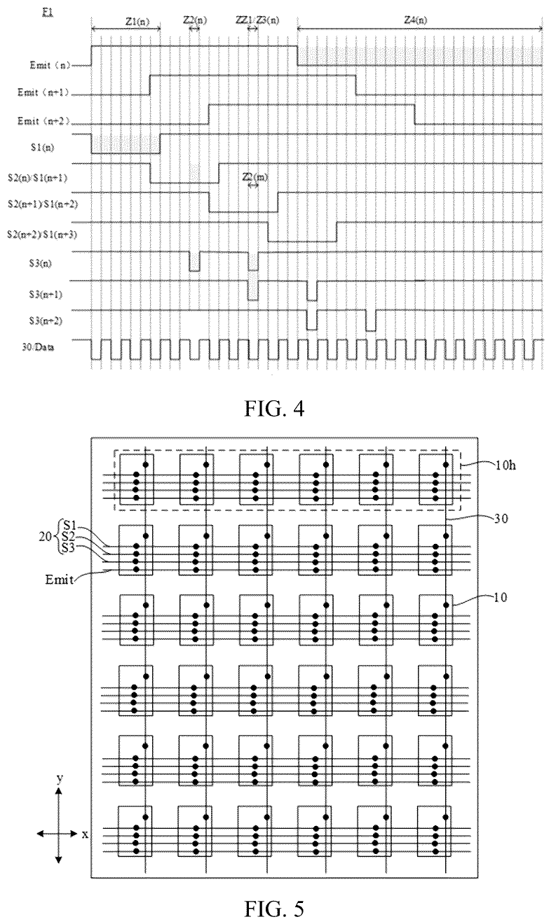

FIG. 4 is another timing diagram according to an embodiment of the present application. FIG. 4 schematically shows the scanning signals S1, S2, and S3 required for an n-th pixel circuit row 10h to an (n+2)th pixel circuit row 10h counted from top to bottom in the display panel. The scanning signal S1(n), scanning signal S2(n), and scanning signal S3(n) correspondingly drive the n-th pixel circuit row 10h. n is a positive integer; for example, when n=1, FIG. 4 schematically shows the signal timings required for the 1st pixel circuit row 10h to 3rd pixel circuit row 10h counted from top to bottom in the display panel. FIG. 4 also schematically shows the data voltage Data provided on one data line 30.

The reset stage Z1(n), data writing stage Z2(n), bias stage Z3(n), and light-emitting stage Z4(n) of the pixel circuit 10 in the n-th pixel circuit row 10h are marked in FIG. 4. As shown in FIG. 4, in the writing frame F1.

In the n-th pixel circuit row 10h, the data writing transistor M1 is turned on in the data writing stage Z2(n) to write the data voltage Data to the driving transistor Tm;

The bias stage Z3(n) of the pixel circuit 10 in the n-th pixel circuit row 10h and the

data writing stage Z2(m) of the pixel circuit 10 in the m-th pixel circuit row 10h at least partially overlap with each other in time, and the overlapping period is a first period ZZ1; n and m are both positive integers, and |n-m|≥1. FIG. 4 is schematically shown with m=n+1. As can be seen from FIG. 4, the second low level of the scanning signal S3(n) controls the data writing transistor M1 in the n-th pixel circuit row 10h to be turned on to provide the first bias voltage to the driving transistor Tm. The second low level period of the scanning signal S3(n) overlaps with the first low level period of the scanning signal S3(n+1), and the first low level of the scanning signal S3(n+1) controls the data writing transistor M1 in the (n+1)th pixel circuit row 10h to be turned on to write the data voltage Data to the driving transistor Tm. Therefore, the overlapping period between the second low level of the scanning signal S3(n) and the first low level of the scanning signal S3(n+1) is the first period ZZ1.

In the first period ZZ1, the data writing transistor M1 in the m-th pixel circuit row 10h is turned on, the data line 30 writes the data voltage Data to the driving transistor Tm, the data writing transistor M1 in the n-th pixel circuit row 10h is turned on, the data line 30 writes the first bias voltage P1 to the driving transistor Tm, and the data voltage Data provided by the data line 30 is reused is reused as the first bias voltage P1.

In the embodiment of the present application, the plurality of pixel circuit rows 10h are arranged in the second direction y, and during display, the plurality of pixel circuit rows 10h are driven row by row to realize one frame display. The data lines 30 are connected to the plurality of pixel circuits 10 arranged in the second direction y, and in one frame, for example, in the writing frame F1, one data line 30 writes the data voltage Data to the pixel circuits 10 in the plurality of pixel circuit rows 10h. In one frame, the data line 30 transmits the data voltage Data with voltage jump, and the data voltage Data is related to the gray level of the light-emitting device PD connected to the pixel circuit 10 connected thereto. In the embodiment of the present application, in the writing frame F1, the data writing transistor M1 of the pixel circuit 10 is turned on twice, the data writing transistor M1 is turned on once to write the data voltage Data, and turned on another time to write the first bias voltage to the first electrode of the driving transistor Tm. The data voltage Data is reused as the first bias voltage, and in the writing frame F1, in the bias stage Z3 corresponding to the pixel circuit 10 in the n-th pixel circuit row 10h, the data voltage Data written in the data writing stage Z2 of the pixel circuit 10 in the m-th pixel circuit row 10h is used to perform bias adjustment on the driving transistor Tm in the n-th pixel circuit row 10h. In the writing frame F1, it is only necessary to add an enable level to the signal received by the data writing transistor M1 to increase the number of times the data writing transistor M1 is turned on, without adjusting the signal provided by the data line 30, and thus the adjustment of the bias state of the driving transistor Tm by reusing the data writing transistor M1 in the writing frame F1 is achieved in a relatively simple control manner.

In some implementations, as shown in FIG. 2, the operation of the pixel circuit 10 includes the light-emitting stage Z4, in which the driving transistor Tm generates the driving current. In the writing frame F1: the bias stage Z3 is between the data writing stage Z2 and the light-emitting stage Z4. That is, in the operation cycle of the pixel circuit 10, after the data voltage Data is written and before the driving transistor Tm generates the driving current, the data writing transistor M1 is used to perform bias adjustment on the driving transistor Tm. That is, in the writing frame F1, the driving transistor Tm is subjected to bias adjustment before it operates in the forward bias state, thereby improving the threshold shift of the driving transistor Tm.

As shown in FIG. 1, the pixel circuit 10 includes the first light-emitting control transistor M5 and the second light-emitting control transistor M6, and the driving transistor Tm is connected between the first light-emitting control transistor M5 and the second light-emitting control transistor M6. The display panel includes a first scan line S3 and a light-emitting control line Emit, the first scan line S3 provides the scanning signal S3, the light-emitting control line Emit provides the light-emitting control signal Emit, the scan line and the scanning signal provided by the scan line adopt the same reference sign, and the light-emitting control line Emit and the signal provided by the light-emitting control line adopt the same reference sign. The control terminal of the data writing transistor MI is connected to the first scan line S3, and a control terminal of the first light-emitting control transistor M5 and a control terminal of the second light-emitting control transistor M6 are connected to the light-emitting control line Emit. In conjunction with the display panel schematically shown in FIG. 3, the scan line 20 includes the first scan line S3, and an extension direction of the light-emitting control line Emit is the same as an extension direction of the scan line 20, that is, one light-emitting control line Emit is connected to a plurality of pixel circuits 10 in at least one pixel circuit row 10h.

In conjunction with the timing diagram schematically shown in FIG. 2, in the writing frame F1:

The first scan line S3 controls the data writing transistor M1 to be turned on in the data writing stage Z2 and controls the data writing transistor M1 to be turned on in the bias stage Z3. For example, the first scan line S3 provides a first low level to control the data writing transistor MI to be turned on in the data writing stage Z2, and provides a second low level to control the data writing transistor MI to be turned on in the bias stage Z3.

The light-emitting control line Emit controls the first light-emitting control transistor M5 and the second light-emitting control transistor M6 to be turned on in the light-emitting stage Z4; where

a time interval t1 exists between the end moment when the first scan line S3 provides an effective level in the bias stage Z3 and the start moment when the light-emitting control line Emit provides an effective level in the light-emitting stage Z4, and t1≥H, where H is row scanning time. The H scanning time is the scanning time allocated to one pixel circuit row 10h in one frame display, and the row scanning time is obtained by dividing the display time of one frame by the number of pixel circuit rows 10h in the display panel. FIG. 2 schematically shows that there is a certain time interval between the end moment of the second low level of the signal provided by the first scan line S3 and the start moment of the low level of the signal provided by the light-emitting control line Emit.

In the embodiment of the present application, in the writing frame F1, the first scan line S3 provides an effective level to control the data writing transistor M1 to be turned on in the data writing stage Z2, and provides an effective level to control the data writing transistor M1 to be turned on in the bias stage Z3. Setting a certain time interval between the end moment when the first scan line S3 provides the effective level and the start moment when the light-emitting control line Emit provides the effective level in the writing frame F1 can ensure that the driving transistor Tm has sufficient time for resetting, thereby ensuring the brightness of the light-emitting device PD at the initial moment of the light-emitting stage Z4.

In some implementations, FIG. 5 is a schematic diagram of another display panel according to an embodiment of the present application, and FIG. 5 schematically shows a plurality of signal lines arranged in the display panel. It should be understood in conjunction with the pixel circuit 10 schematically shown in FIG. 1. FIG. 1 shows that the threshold compensation transistor M3 in the pixel circuit 10 is connected between a second electrode of the driving transistor Tm and a control terminal of the driving transistor Tm.

As shown in FIG. 5, the scan line 30 extending along the first direction x in the display panel includes the first scan line S3, a second scan line S2 and a third scan line S1. The control terminal of the data writing transistor M1 is connected to the first scan line S3, the control terminal of the threshold compensation transistor M3 is connected to the second scan line S2, and the control terminal of the gate reset transistor M2 is connected to the third scan line S1. Also shown is the light-emitting control line Emit that provides the light-emitting control signal Emit. In conjunction with the timing diagram schematically shown in FIG. 2, each scan line and the scanning signal provided by the scan line adopt the same reference sign, for example, the first scan line S3 provides the scanning signal S3. In the writing frame F1:

The first scan line S3 controls the data writing transistor M1 to be turned on in the data writing stage Z2 and controls the data writing transistor M1 to be turned on in the bias stage Z3; and

The second scan line S2 controls the threshold compensation transistor M3 to be turned on in the data writing stage Z2. As schematically shown in the timing diagram in FIG. 2, in the overlapping period when the second scan line S2 provides an effective level and the first scan line S3 provides an effective level, the data voltage Data is written to the gate of the driving transistor Tm, and the threshold voltage of the driving transistor Tm is compensated.

FIG. 2 schematically shown with the low level provided by each scan line as the effective level. As can be seen from FIG. 2, a time interval t2 exists between the end moment when the second scan line S2 provides the effective level and the start moment when the first scan line S3 provides the effective level in the bias stage Z3, and t2≥H, where H is row scanning time. The H scanning time is the scanning time allocated to one pixel circuit row 10h in one frame display, and the row scanning time is obtained by dividing the display time of one frame by the number of pixel circuit rows 10h in the display panel.

In the embodiment of the present application, setting a certain time interval between the end moment when the second scan line S2 provides the effective level and the start moment when the first scan line S3 provides the effective level in the bias stage Z3 in the writing frame F1 can ensure that the threshold compensation transistor M3 is completely turned off at the initial moment when the data writing transistor M1 is turned on in the bias stage Z3. In this way, the bias voltage written in the bias stage Z3 is prevented from affecting the potential of the gate of the driving transistor Tm.

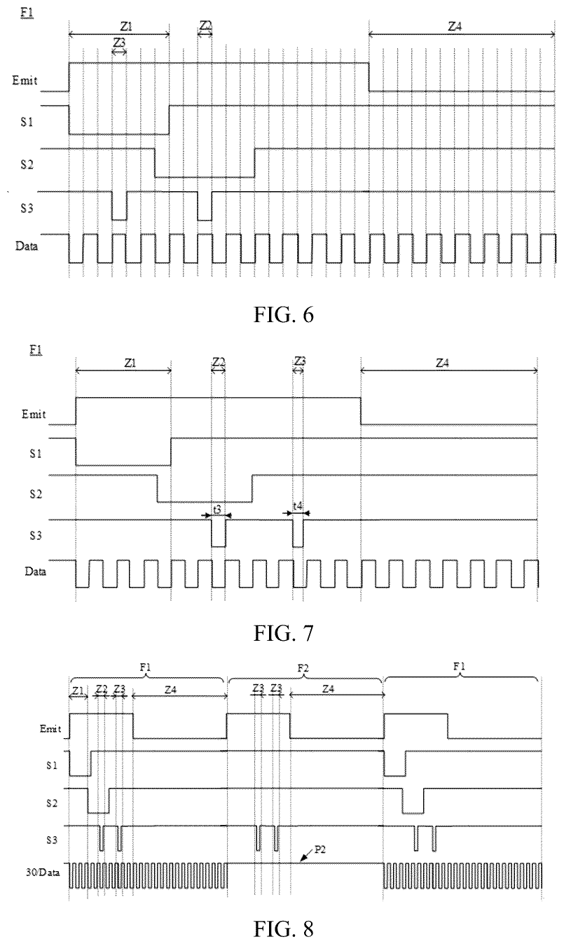

In some implementations, FIG. 6 is a timing diagram of another pixel circuit according to an embodiment of the present application. The operation of the pixel circuit 10 in the writing frame F1 is understood in conjunction with FIG. 1. As shown in FIG. 1, the pixel circuit includes the gate reset transistor M2 connected to the control terminal of the driving transistor Tm. The operation of the pixel circuit includes the gate reset stage Z1, in which the gate reset transistor M2 is turned on to reset the control terminal of the driving transistor Tm.

As shown in FIG. 6, in the writing frame F1, the operation of the pixel circuit includes the gate reset stage Z1, the data writing stage Z2, the bias stage Z3 and the light-emitting stage Z4. In the gate reset stage Z1, the gate reset transistor M2 is turned on to reset the gate of the driving transistor Tm; in the data writing stage Z2, the data writing transistor M1 and the threshold compensation transistor M3 are turned on to write the data voltage Data to the gate of the driving transistor Tm and compensate the threshold voltage of the driving transistor Tm; in the bias stage Z3, the data writing transistor M1 is turned on to write the first bias voltage P1 to the first electrode of the driving transistor Tm; and in the light-emitting stage Z4, the first light-emitting control transistor M5 and the second light-emitting control transistor M6 are turned on, and the driving transistor Tm generates the driving current.

The bias stage Z3 and the gate reset stage Z1 at least partially overlap with each other in time. The gate reset transistor M2 receives the scanning signal S1, and the data writing transistor M1 receives the scanning signal S3; and thus the period of the effective level of the scanning signal S3 at least partially overlaps with the period of the effective level of the scanning signal S1.

In these implementations, setting the gate reset stage Z1 and the bias stage Z3 to at least partially overlap with each other in the writing frame F1 can fully utilize the operating cycle of the pixel circuit 10, reduce the impact on the duration of the operating cycle of the pixel circuit 10 caused by using the data writing transistor M1 for bias adjustment in the writing frame F1, and avoid affecting the total time of one frame display and the display refresh rate.

As shown in FIG. 6, in the writing frame F1: the start moment of the bias stage Z3 is not earlier than the start moment of the gate reset stage Z1, and the end moment of the bias stage Z3 is not earlier than the end moment of the gate reset stage Z1. In these implementations, the gate reset stage Z1 in the writing frame F1 is set to cover the bias stage Z3, that is, the process of writing the bias voltage to the first electrode of the driving transistor Tm by using the data writing transistor M1 is completed within the gate reset stage Z1. In this way, it is possible to avoid the addition of the bias stage Z3 in the writing frame F1 from affecting the duration of the operating cycle of the pixel circuit 10.

In further implementations, FIG. 7 is a schematic diagram of another pixel circuit according to an embodiment of the present application. As shown in FIG. 7, in the writing frame F1: a duration of the data writing stage Z2 is t3, and a duration of the bias stage Z3 is t4, with t3≥t4. That is, in the writing frame F1, the duration of the bias stage Z3 is not longer than the duration of the data writing stage Z2. Such a setting not only ensures that the duration of the data writing stage Z2 is sufficiently long to ensure the full writing of the data voltage Data, but also allow a period of time to be set in the writing frame F1 to perform bias adjustment on the driving transistor Tm by using the data writing transistor M1. Adjusting the bias state of the driving transistor Tm by using the data writing transistor M1 in the writing frame F1 can improve the display unevenness caused by the threshold shift of the driving transistor Tm operating in a forward bias state for a long time, and at the same time, ensure that setting the bias stage Z3 in the writing frame F1 has little impact on the operating cycle of the pixel circuit 10, so as to avoid affecting the total time of one frame display and the display refresh rate.

In conjunction with the schematic of FIG. 5, the display panel includes the first scan line S3, and the control terminal of the data writing transistor M1 is connected to the first scan line S3. The first scan line S3 provides the scanning signal S3. In the writing frame F1: the duration for which the first scan line S3 provides an effective level in the data writing stage Z2 is t3, and the duration for which the first scan line S3 provides an effective level in the bias stage Z3 is t4. The on or off state of the data writing transistor M1 is controlled by the first scan line S3, and the durations of the data writing stage Z2 and the bias stage Z3 in the writing frame F1 are controlled by controlling the durations for which the first scan line S3 provides the effective levels in the data writing stage Z2 and the bias stage Z3.

In further implementations, the display panel further includes a holding frame, and an operation of the pixel circuit 10 in the holding frame includes the bias stage Z3 and the light emitting stage Z4. FIG. 8 is a timing diagram of another pixel circuit according to an embodiment of the present application. FIG. 8 shows the operation timing of the pixel circuit 10 in the writing frame F1 and the holding frame F2. As shown in FIG. 8, the operation of the pixel circuit 10 in the writing frame F1 includes the reset stage Z1, the data writing stage Z2, the bias stage Z3 and the light-emitting stage Z4, and the operation of the pixel circuit 10 in the holding frame F2 includes the bias stage Z3 and the light-emitting stage Z4. At least one holding frame F2 is provided between two adjacent writing frames F1. In the holding frame F2: the data writing transistor M1 is turned on in the bias stage Z3, and a second bias voltage P2 is written to the first electrode of the driving transistor Tm. The second bias voltage P2 is used for the bias adjustment of the driving transistor Tm in the holding frame F2. An optional range of the voltage value of the second bias voltage P2 is V_{GMP}-1V˜V_{GMP}, and V_{GMP} is the dark state voltage of the light-emitting device PD.

No data writing stage Z2 is provided in the holding frame F2, that is, in the holding frame F2, the light-emitting device PD maintains the brightness of the writing frame F1 for display. Providing the bias stage Z3 in the non-light-emitting period of the holding frame F2 to adjust the bias state of the driving transistor Tm can improve the display unevenness caused by the threshold shift due to the driving transistor Tm operating in a forward bias state for a long time.

As shown in the timing diagram in FIG. 8, in the holding frame F2, both the scanning signal S1 and the scanning signal S2 are constant voltage signals, so that the holding frame F2 does not include the gate reset stage and the data writing stage.

In some implementations, three holding frames F2 are provided between two adjacent writing frames F1. In this way, the low refresh rate of the display panel is realized, and when displaying some special scenes, such as static pictures, the power consumption of the display panel can be reduced.

In some implementations, as shown in FIG. 8, in the holding frame F2, the operation of the pixel circuit 10 includes two bias stages Z3. That is, the data writing transistor M1 is turned on twice in the holding frame F2 to perform bias adjustment on the driving transistor Tm twice, which makes the bias adjustment effect on the driving transistor Tm better.

In conjunction with the above-mentioned FIG. 5, the display panel includes the first scan line S3, the control terminal of the data writing transistor M1 in the pixel circuit 10 is connected to the first scan line S3, and the first scan line S3 provides the scanning signal S3.

As shown in FIG. 8, the pulse signal provided by the first scan line S3 in the writing frame F1 is the same as the pulse signal provided by the first scan line S3 in the holding frame F2. The display panel provided by this embodiment can provide the same signal to the first scan line S3 in the holding frame F2 and the writing frame F1, which can simplify the signal generation mode of the first scan line S3 and simplify the control mode of the display panel. Moreover, while ensuring that the data writing transistor M1 is used for bias adjustment in the writing frame F1, the number of bias adjustments can also be increased in the holding frame F2, thereby making the bias adjustment effect on the driving transistor Tm better.

As shown in FIG. 1, the pixel circuit 10 includes the electrode reset transistor M4 connected to one electrode of the light-emitting device PD, where the control terminal of the electrode reset transistor M4 and the control terminal of the gate reset transistor M2 receive the same signal.

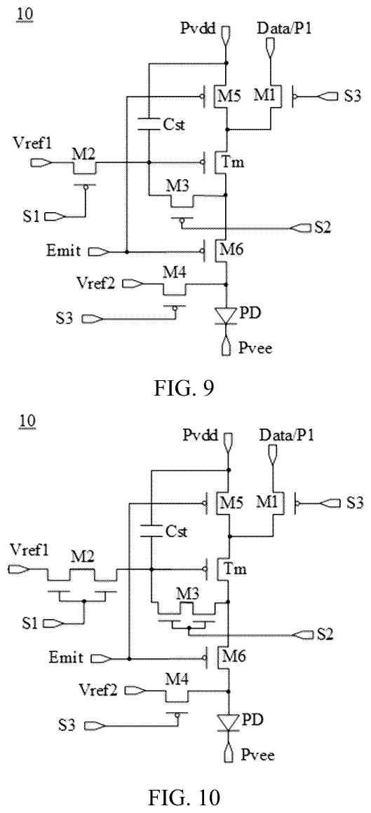

In another embodiment, FIG. 9 is a schematic diagram of another pixel circuit according to an embodiment of the present application. As shown in FIG. 9, both the control terminal of the electrode reset transistor M4 and the control terminal of the data writing transistor M1 receive the scanning signal S3. In conjunction with FIG. 5, the first scan line S3 is arranged in the display panel, and it is set that the control terminal of the electrode reset transistor M4 and the control terminal of the data writing transistor M1 are connected to the first scan line S3. In the embodiment of the present application, in the writing frame F1, the first scan line S3 controls the data writing transistor M1 to be turned on in the data writing stage Z2 to write the data voltage Data to the driving transistor Tm, and also controls the data writing transistor M1 to be turned on in the bias stage Z3 to write the first bias voltage to the first electrode of the driving transistor Tm. Then, in the writing frame F1, the first scan line S3 also controls the electrode reset transistor M4 to be turned on in the data writing stage Z2 to reset the electrode of the light-emitting device PD, and also controls the electrode reset transistor M4 to be turned on in the bias stage Z3 to reset the electrode of the light-emitting device PD. The time for resetting the light-emitting device PD is increased, and the light-emitting device PD can be reset more completely.

In some implementations, as shown in FIG. 1 or FIG. 9, a first electrode of the gate reset transistor M2 receives a first reset signal Vref1, a first electrode of the electrode reset transistor M4 receives a second reset signal Vref2, and voltage values of the first reset signal Vref1 and the second reset signal Vref2 are different. Optionally, the voltage value of the second reset signal Vref2 is less than the voltage value of the first reset signal Vref1. By providing a lower reset voltage to the electrode of the light-emitting device PD, the unintended illumination of the light-emitting device PD can be alleviated, and the low gray level display effect can be improved. Meanwhile, by providing a higher reset voltage to the gate of the driving transistor Tm, the threshold capture of the gate of the driving transistor Tm is enabled to be faster. When applied to high-frequency display or low-brightness (or gray level) display, the time of the threshold capture of the gate of the driving transistor Tm is shorter, and the faster the threshold capture of the gate of the driving transistor Tm is, the more accurate the threshold capture can be, which can alleviate display unevenness and improve the display effect.

In further implementations, the first electrode of the electrode reset transistor M4 and the first electrode of the gate reset transistor M2 receive the same reset voltage. The first electrode of the electrode reset transistor M4 and the first electrode of the gate reset transistor M2 can also be electrically connected to the same reset signal line.

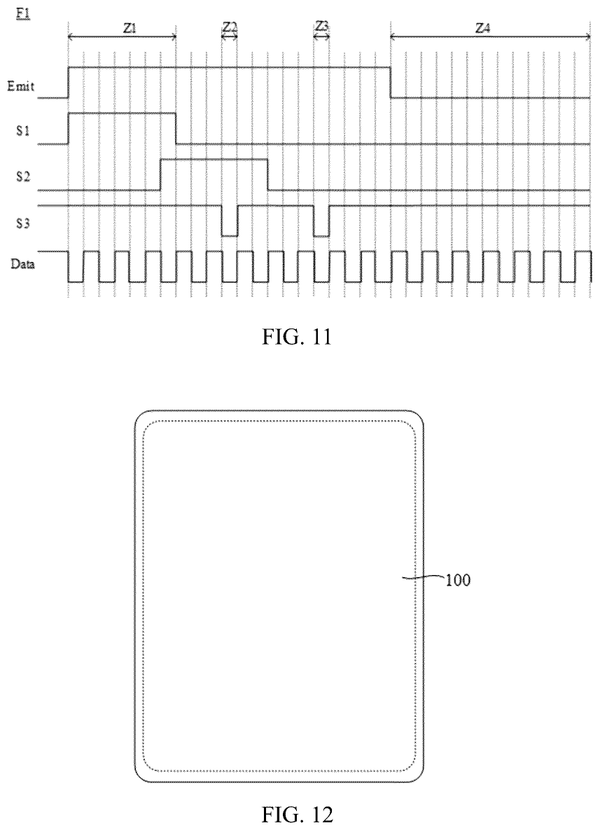

In further implementations, FIG. 10 is a schematic diagram of another pixel circuit according to an embodiment of the present application, FIG. 11 is an operation timing diagram of the another pixel circuit according to an embodiment of the present application, and FIG. 11 is the operation timing diagram of the pixel circuit provided in FIG. 10 in a writing frame F1. As shown in FIG. 10, the pixel circuit 10 includes a driving transistor Tm, a data writing transistor M1, a gate reset transistor M2, a threshold compensation transistor M3, an electrode reset transistor M4, a first light-emitting control transistor M5, a second light-emitting control transistor M6, and a storage capacitor Cst. The gate reset transistor M2 is connected to a control terminal of the driving transistor Tm, and the threshold compensation transistor M3 is connected between the control terminal of the driving transistor Tm and a second electrode of the driving transistor Tm; and the gate reset transistor M2 and the threshold compensation transistor M3 are n-type transistors, and the rest transistors are p-type transistors. An active layer of the gate reset transistor M2 and an active layer of the threshold compensation transistor M3 include metal oxides.

In conjunction with FIG. 11, the display panel includes the writing frame F1, in which an operation of the pixel circuit includes a reset stage Z1, a data writing stage Z2, a bias stage Z3 and a light-emitting stage Z4.

In the reset stage Z1, a scanning signal S1 provides a high-level effective level to control the gate reset transistor M2 to be turned on to reset a gate of the driving transistor Tm.

In the data writing stage Z2, a scanning signal S2 provides a high-level effective level to control the threshold compensation transistor M3 to be turned on, and a scanning signal S3 provides a low-level effective level to control the data writing transistor M1 to be turned on to write a data voltage Data to the gate of the driving transistor Tm and compensate a threshold voltage of the driving transistor Tm.

In the bias stage Z3, the scanning signal S3 provides a low-level effective level to control the data writing transistor M1 to be turned on to write the first bias voltage P1 to a first electrode of the driving transistor Tm, and use the first bias voltage P1 to adjust a bias state of the driving transistor Tm.

In the light-emitting stage Z4, the light-emitting control signal Emit provides an effective level to control the first light-emitting control transistor M5 and the second light-emitting control transistor M6 to be turned on, the driving transistor Tm generates a driving current and provides the driving current to a first electrode of the light-emitting device PD, and the light-emitting device PD emits light under control of voltages of a first electrode and a second electrode thereof.

In these implementations, setting the active layer of the gate reset transistor M2 and the active layer of the threshold compensation transistor M3 to include metal oxides can reduce the leakage current of the gate reset transistor M2 and the threshold compensation transistor M3 to the gate of the driving transistor Tm in a turned-off state, and can improve the potential stability of the gate of the driving transistor Tm in the light-emitting stage Z4, thereby improving the display effect. Moreover, in these implementations, the operation of the pixel circuit 10 in the writing frame F1 is set to include the data writing stage Z2 and the bias stage Z3, the data writing transistor M1 is turned on once in the data writing stage Z2 to write the data voltage Data to the driving transistor Tm, and turned on once in the bias stage Z3 to write the first bias voltage P1 to the first electrode of the driving transistor Tm. Using the data writing transistor M1 to write the first bias voltage P1 in the writing frame F1 to adjust the bias state of the driving transistor Tm can improve the display unevenness caused by the threshold shift due to the driving transistor Tm operating in a forward bias state for a long time.

Based on the same inventive concept, an embodiment of the present application further provides a display apparatus. FIG. 12 is a schematic diagram of a display apparatus according to an embodiment of the present application. As shown in FIG. 12, the display apparatus includes the display panel 100 according to any of the embodiment of the present application. The structure of the display panel 100 has been described in the above embodiments, and will not be repeated herein. The display apparatus according to the embodiment of the present application may be an electronic device with a display function, such as a tablet, a mobile phone, a computer, or a television.

The above are merely preferred embodiments of the present application and are not intended to limit the present application. Any modification, equivalent replacement, improvement, etc., made within the spirit and principle of the present application shall be included in the protection scope of the present application.

Finally, it should be noted that the above embodiments are merely used to illustrate the technical solutions of the present application, rather than limiting them; although the present application has been described in detail with reference to the foregoing embodiments, those of skill in the art should understand that they can still modify the technical solutions recited in the foregoing embodiments, or equivalently replace some or all of the technical features therein; and these modifications or replacements do not make the essence of the corresponding technical solutions deviate from the scope of the technical solutions of the embodiments of the present application.

What is claimed is:

1. A display panel, comprising a plurality of pixel circuits and a plurality of light-emitting devices, wherein the pixel circuits are electrically connected to the light-emitting devices, each pixel circuit comprises a driving transistor and a data writing transistor, the driving transistor is configured to generate a driving current, and the data writing transistor is electrically connected to a first electrode of the driving transistor;
wherein an operation of the pixel circuit comprises a data writing stage and a bias stage; and
wherein the display panel further comprises a writing frame, and in the writing frame:
the data writing transistor is turned on in the data writing stage to write a data voltage to the driving transistor; and
the data writing transistor is turned on in the bias stage to write a first bias voltage to the first electrode of the driving transistor.

2. The display panel according to claim 1, wherein
the plurality of pixel circuits are arranged in a plurality of pixel circuit rows in a first direction, and the plurality of pixel circuit rows are arranged in a second direction, the second direction intersecting with the first direction;
the display panel further comprises a data line extending in the second direction, the data line being electrically connected to the data writing transistors in multiple pixel circuits arranged in the second direction; and
in the writing frame:
the data writing transistor in an n-th pixel circuit row is turned on in the data writing stage to write the data voltage to the driving transistor;
the bias stage of the pixel circuit in the n-th pixel circuit row and the data writing stage of the pixel circuit in an m-th pixel circuit row at least partially overlap with each other in time, and an overlapping period is a first period; and n and m are both positive integers, and |n-m|≥1; and
in the first period, the data writing transistor in the m-th pixel circuit row is turned on, the data line writes the data voltage to the driving transistor, the data writing transistor in the n-th pixel circuit row is turned on, the data line writes the first bias voltage to the driving transistor, and the data voltage provided by the data line is reused as the first bias voltage.

3. The display panel according to claim 1, wherein
the operation of the pixel circuit further comprises a light-emitting stage, in which the driving transistor generates the driving current; and
in the writing frame: the bias stage is between the data writing stage and the light-emitting stage.

4. The display panel according to claim 3, wherein
the pixel circuit further comprises a first light-emitting control transistor and a second light-emitting control transistor, and the driving transistor is connected between the first light-emitting control transistor and the second light-emitting control transistor;
the display panel further comprises a first scan line and a light-emitting control line, a control terminal of the data writing transistor is connected to the first scan line, and a control terminal of the first light-emitting control transistor and a control terminal of the second light-emitting control transistor are connected to the light-emitting control line; and
in the writing frame:
the first scan line controls the data writing transistor to be turned on in the data writing stage and controls the data writing transistor to be turned on in the bias stage;
the light-emitting control line controls the first light-emitting control transistor and the second light-emitting control transistor to be turned on in the light-emitting stage; and
a time interval t1 exists between an end moment when the first scan line provides an effective level in the bias stage and a start moment when the light-emitting control line provides an effective level in the light-emitting stage, t1≥H, and H is a row scanning time.

5. The display panel according to claim 3, wherein
the pixel circuit further comprises a threshold compensation transistor connected between a second electrode of the driving transistor and a control terminal of the driving transistor;
the display panel further comprises a first scan line and a second scan line, a control terminal of the data writing transistor is connected to the first scan line, and a control terminal of the threshold compensation transistor is connected to the second scan line; and
in the writing frame:
the first scan line controls the data writing transistor to be turned on in the data writing stage and controls the data writing transistor to be turned on in the bias stage;
the second scan line controls the threshold compensation transistor to be turned on in the data writing stage; and
a time interval t2 exists between an end moment when the second scan line provides an effective level and a start moment when the first scan line provides an effective level in the bias stage, t2≥H, and H is a row scanning time.

6. The display panel according to claim 1, wherein
the pixel circuit further comprises a gate reset transistor connected to a control terminal of the driving transistor;
the operation of the pixel circuit further comprises a gate reset stage, and the gate reset transistor is turned on in the gate reset stage to reset the control terminal of the driving transistor; and
in the writing frame: the bias stage and the gate reset stage at least partially overlap with each other in time.

7. The display panel according to claim 6, wherein
in the writing frame:
a start moment of the bias stage is not earlier than a start moment of the gate reset stage, and an end moment of the bias stage is not earlier than an end moment of the gate reset stage.

8. The display panel according to claim 1, wherein
in the writing frame:
a duration of the data writing stage is t3, a duration of the bias stage is t4, and t3≥t4.

9. The display panel according to claim 8, wherein
the display panel further comprises a first scan line, and a control terminal of the data writing transistor is connected to the first scan line; and
in the writing frame: a duration for which the first scan line provides an effective level in the data writing stage is t3, and a duration for which the first scan line provides the effective level in the bias stage is t4.

10. The display panel according to claim 1, wherein
the display panel further comprises a holding frame, and at least one holding frame is provided between two adjacent writing frames; and
in the holding frame: the data writing transistor is turned on in the bias stage and writes a second bias voltage to the first electrode of the driving transistor.

11. The display panel according to claim 10, wherein
in the holding frame, the operation of the pixel circuit comprises two bias stages.

12. The display panel according to claim 11, wherein
the display panel comprises a first scan line, and a control terminal of the data writing transistor is connected to the first scan line; and
a pulse signal provided by the first scan line in the writing frame is the same as a pulse signal provided by the first scan line in the holding frame.

13. The display panel according to claim 1, wherein
the pixel circuit further comprises an electrode reset transistor connected to one electrode of one of the light-emitting devices;
the display panel further comprises a first scan line; and
a control terminal of the electrode reset transistor and a control terminal of the data writing transistor are connected to the first scan line.

14. The display panel according to claim 1, wherein
the pixel circuit comprises a gate reset transistor and a threshold compensation transistor, the gate reset transistor is connected to a control terminal of the driving transistor, and the threshold compensation transistor is connected between the control terminal of the driving transistor and a second electrode of the driving transistor; and
an active layer of the gate reset transistor and an active layer of the threshold compensation transistor comprise metal oxide.

15. A display apparatus, comprising a display panel, wherein the display panel comprises a plurality of pixel circuits and a plurality of light-emitting devices, wherein the pixel circuits are electrically connected to the light-emitting devices, each pixel circuit comprises a driving transistor and a data writing transistor, the driving transistor is configured to generate a driving current, and the data writing transistor is electrically connected to a first electrode of the driving transistor;
wherein an operation of the pixel circuit comprises a data writing stage and a bias stage; and
wherein the display panel further comprises a writing frame, and in the writing frame:
the data writing transistor is turned on in the data writing stage to write a data voltage to the driving transistor; and
the data writing transistor is turned on in the bias stage to write a first bias voltage to the first electrode of the driving transistor.
